(19) United States
(12) Patent Application Publication
(10) Pub. No.: US 2007/0183416 A1
(43) Pub. Date: Aug. 9, 2007

(54) Per-port penalty queue system for re-prioritization of network traffic sent to a processor

(76) Inventors: Mark Gooch, Roseville, CA (US); Robert L. Faulk JR., Roseville, CA (US); Bruce E. LaVigne, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/350,347

(22) Filed: Feb. 7, 2006

(51) Int. Cl. H04L 12/56

(52) U.S. Cl. 370/389; 370/412

(57) ABSTRACT

In an embodiment of the invention, a method and system for a per-port penalty queue system in a network device includes: selecting a state for a port in the network device; wherein the selected state comprises either a normal state or a restricted state; wherein the normal state permits a packet received at the port to be copied to a first queue; and wherein the restricted state causes the packet to be copied to a penalty queue which has lower priority than the first queue or causes the packet to not be copied to a queue. In another embodiment of the invention, a method and system permit using the port state for modifying a forwarding decision for a packet, so that the penalized packet will use a sub-optimal or less optimal routing path to the packet destination. In another embodiment of the invention, a method and system permit using the port state as a search key into an access control list (ACL) operation related to packet forwarding decisions or packet filtering decisions.

### TECHNICAL FIELD

Embodiments of the invention relate generally to network systems, and more particularly to a per-port penalty queue system for re-prioritization of network traffic sent to a processor. Embodiments of the invention also relate more particularly to a system and method for using the port state for modifying a forwarding decision for a packet. Embodiments of the invention also relate more particularly to a system and method for using the port state as a search key into an access control list (ACL) operation related to packet forwarding decisions or packet filtering decisions.

### BACKGROUND

A typical network switch (or router) has a hardware-based fast path for forwarding packets, and a software/CPU-based slower path for learning packet addresses and connections. Specifically, a network switch (or router) typically includes dedicated hardware for forwarding network packets at high speed by using forwarding table lookups (e.g., hashing, content addressable memories or CAMS, etc.), and one or more central processing unit (CPU) subsystems that are used to program the forwarding tables. The CPU is also responsible for maintaining network operation by using specific network protocols (e.g., handling route updates, address resolution protocol (ARP) queries/replies, Internet Control Message Protocol (ICMP) messages, spanning tree related packets, etc.) as well as user interface functionality.

Packets that are sent to a CPU (i.e., packets that are “copied”) are typically prioritized into one of a number of CPU queues (typically from 2 to 8 queues). The memory space of the CPU will typically contain these queues that will be serviced in priority order, i.e., packet traffic placed in the highest priority queue will be processed first before processing packet traffic placed in the lower priority queues. Packets in the lower priority queues may even be discarded should the packet rate to the CPU exceed the packet rate which the CPU can actually process. Thus it is important to correctly prioritize packets into the correct CPU queue.

Traffic is copied to a CPU for a number of reasons. For example, traffic is copied because the traffic packets are being sampled, have unknown addresses (e.g., learns, moves, unknown destination addresses), are formed by protocol packets (e.g., routing protocols, Internet Group Management Protocol (IGMP) packets, Protocol Independent Multicast (PIM) packets, ICMP packets), or are copied for other reasons. Typically, different traffic types are assigned to different CPU queues, thus allowing the CPU to process more important packets first prior to processing the less important packets. However, when a port is receiving many packets that generate security violations, it would be beneficial to restrict the CPU queue that such violation packets can be placed in, or even not copy the packets at all.

Prior solutions to this problem of unusual traffic patterns are typically static and are based on simplistic criteria such as packet type and packet protocol, and as a result, these prior solutions are suboptimal. Responses of prior solutions are not restricted solely to the offending port, and thus have the undesirable affect of penalizing or dropping packets from well-behaved ports. The lack of adaptability and per-port configuration makes such current solutions suboptimal during unusual traffic patterns that require a large amount of traffic from a port to be copied to the CPU (e.g., during a denial of service type attack, virus propagation, etc.). In other words, the prior solutions are unable to deal with the problem of unusual packet traffic patterns that can cause network problems.

Therefore, the current technology is limited in its capabilities and suffers from at least the above constraints and deficiencies.

### SUMMARY OF EMBODIMENTS OF THE INVENTION

An embodiment of the invention provides a method and system for a per-port penalty queue system in a network device including: selecting a state for a port in the network device; wherein the selected state comprises either a normal state or a restricted state; wherein the normal state permits a packet received at the port to be copied to a first queue; and wherein the restricted state causes the packet to be copied to a penalty queue which has lower priority than the first queue or causes the packet to not be copied to a queue. In an embodiment of the invention, a restricted state may be the penalty queue state or the violation disable state, as discussed below.

An advantage of embodiments of this invention is that the CPU can be protected from being overwhelmed by packet traffic from a specific port (or ports) during errant (e.g., malicious or abnormal) network behavior, such as that which may be seen during denial of service (DoS) type attacks on a network, virus propagation, or other types of conditions. Embodiments of the invention permits different states to be configured on a per-port basis, and allows two levels of restrictions to be placed on copied packets—CPU queue re-prioritization (penalty queue) and/or violation disable. These features improve the robustness of both the network device (e.g., switch or router) and the network during such abnormal traffic conditions.

Another embodiment of the invention also provides a system and method for using the port state for modifying a forwarding decision for a packet, so that the penalized packet will use a different routing path (e.g., a sub-optimal or less optimal routing path) to the packet destination.

Another embodiment of the invention also provides a system and method for using the port state as a search key into an access control list (ACL) operation related to packet forwarding decisions or packet filtering decisions.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (apparatus), in accordance with an embodiment of the invention.

FIG. 2 is a flowchart of a method, in accordance with an embodiment of the invention.

FIG. 3 is a block diagram of a system (apparatus), in accordance with another embodiment of the invention.

FIG. 4 is a flowchart of a method, in accordance with another embodiment of the invention.

FIG. 5 is a block diagram of a subsystem, in accordance with another embodiment of the invention.

FIG. 6 is a block diagram of a subsystem, in accordance with another embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

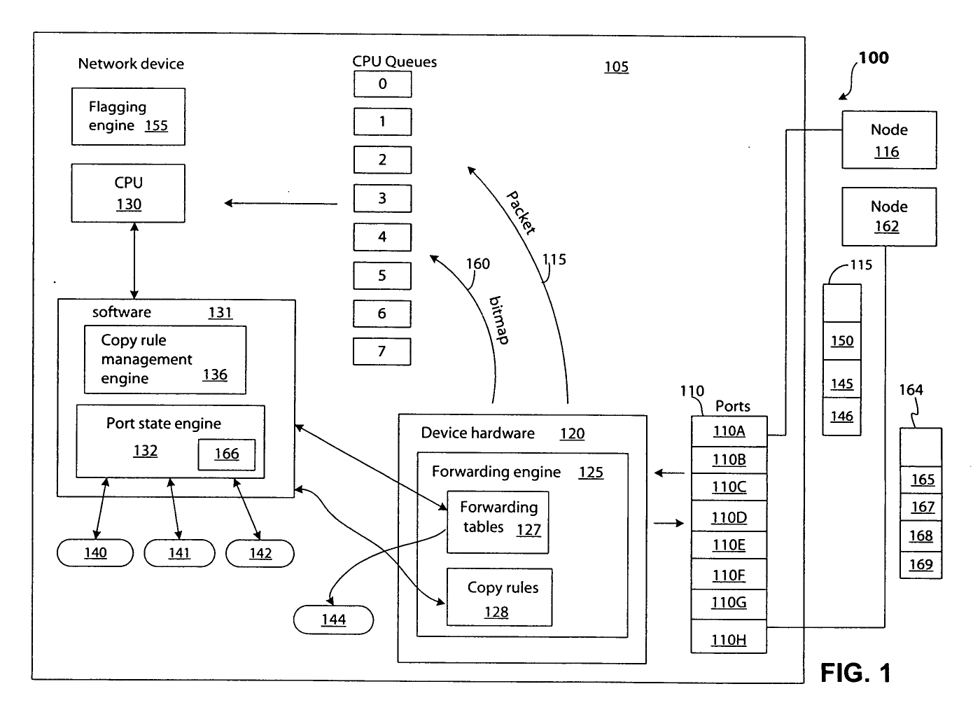

FIG. 1 is a block diagram of a system (apparatus) 100, in accordance with an embodiment of the invention. The system 100 comprises a network device 105 which, for example, typically is a network switch or a router. Each one of the ports 110 in the network device 105 can receive the network packets 115. In the example of FIG. 1, the ports 110A-110H are shown in the network device 105, although the number of ports 110 can vary.

An embodiment of the invention permits a port 110 in the network device 105 to be set in a normal state 140 or in a restricted state. As discussed below, in an embodiment of the invention, a restricted state may be the penalty queue state 141 or the violation disable state 142. Software 131 executing on the CPU 130 has a port state engine 132 that can assign any of the ports 110 to the normal state 140, penalty queue state 141, or violation disable state 142. These states 140, 141, and 142 are discussed in detail below.

Normal State

Typically, after system boot-up or system restart of the network device 105, the port state engine 132 will place each of the ports 110 into the normal state 140. Assume in this example that a packet 115 is received by a port 110A from a node 116, and the port 110A is in the normal state 140, although any other ones of the ports 110 may also be used in this example.

When the port 110A is in the normal state 140, the device hardware 120 will forward the packet 115 at high speed by typically using forwarding table lookups, so that the network device 105 can forward the packet 115 to its next destination. The device hardware 120 will send the packet 115 for processing by the CPU 130, if the packet 115 matches at least one of the copy rules 128 that are maintained in the device hardware 120. An example of a method for comparing the information of the packet 115 with the copy rules 128 is discussed below. Further details on methods for comparing packet information with the copy rules 128 are also discussed in U.S. patent application Ser. No. 11/198,056, by Mark Gooch, Robert L. Faulk, Jr. & Bruce LaVigne, filed on Aug. 5, 2005, and entitled “PRIORITIZATION OF NETWORK TRAFFIC SENT TO A PROCESSOR BY USING PACKET IMPORTANCE”, which is hereby fully incorporated herein by reference.

Typically, a set of copy rules 128 is used for comparison with the packet 115, although only one copy rule 128 could also be used for comparison with the packet 115. The CPU 130 is used to program the forwarding tables 127, to maintain network operation by using specific network protocols (e.g., handling route updates, ARP queries/replies, ICMP messages, spanning tree related packets, etc.), to permit user interface functionality, and to provide other functionalities that are known to those skilled in the art.

When information in the packet 115 matches at least one of the copy rules 128, the packet 115 is forwarded (copied) to the CPU 130 for processing. When a packet 115 is forwarded to the CPU 130, the packet 115 is denoted herein as a “copied” packet. Software 131 executing on the CPU 130 has copy rule management engine code 136 that associates each copy rule 128 with a programmable CPU queue value. Each CPU queue value is, in turn, assigned to a CPU queue. Therefore, the copy rule management engine software 136 assigns each copy rule to a particular CPU queue. Each CPU queue is typically a receive buffer in the memory space of the CPU 130. The device hardware forwarding engine 125 checks the packet 115 against each of the copy rules 128, in order to determine if the forwarding engine 125 should or should not copy the packet 115 to the CPU 130. The forwarding engine 125 also determines which CPU queue should receive the packet 115, by checking the packet 115 against each copy rule 128. In one embodiment, the CPU queue (that will receive the packet 115) is determined by the highest priority copy rule that generates a match. In other words, the CPU queue that will receive the packet 115 will be the CPU queue that is associated with the matching copy rule with the highest priority (if the packet matches with multiple copy rules), or will be the CPU queue that is associated with the copy rule that matches the packet (if the packet matches with only one copy rule).

The forwarding engine 125 checks the packet header 150 to determine which forwarding lookups to perform on the packet 115. The forwarding engine 125 then uses the results of the forwarding lookups (i.e., the forwarding information 144 associated with the packet 115) and the packet header 150 in order to determine if the packet 115 matches any of the copy rules 128. The packet header 150 includes, for example, the packet type information 145, packet source and destination addresses 146, and other information associated with the packet 115. If the forwarding engine 125 determines that the packet 115 does not match any of the copy rules 128, then the forwarding engine 125 will not send the packet 115 to a CPU queue, and as a result, the packet is not sent to the CPU 130 for processing. Regardless of whether or not the packet is copied to the CPU, the results 144 of the forwarding lookups are used to forward the packet 115 out of the device 105, so that the packet 115 continues to be transmitted toward the eventual packet destination.

If the packet 115 matches one or more of the copy rules 128, the forwarding engine 125 will place the packet 115 into an appropriate CPU queue. As an example, assume that the CPU 130 supports 8 CPU queues (CPU queue 0 to CPU queue 7 in the example of FIG. 1). Note that the number of CPU queues supported by the CPU 130, the number of copy rules 128, and/or the reason associated with the copy rule (i.e., packet defined by the copy rule), may vary, depending on the desired functionality or functionalities in the network device 105. For example, if the network device 105 is not a router, then RULE02 (see Table 1 below) would typically not be included in the copy rules 128 because the network device would not need the route update information. The priority of each copy rule 128 may also vary or may be dynamically configurable or changeable, as discussed in the above cited U.S. patent application Ser. No. 11/198,056. Additionally, in another embodiment of the invention, multiple CPUs may be implemented in a network device, as discussed below in additional detail.

In the above example, assume that there are 4 copy rules 128 which are listed in Table 1 below in priority order (from lowest priority rule to highest priority rule). Therefore, RULE00 is the lowest priority rule and RULE03 is the highest priority rule. Each of these rules is assigned to a particular CPU queue. A flagging engine 155 may also be implemented for informing the CPU 130 that a packet 115 has been placed in a CPU queue.

In the above example, the copy rules 128, the reason corresponding to the copy rule (i.e., the packet defined by each particular copy rule 128), and the assigned CPU queue for each particular copy rule 128, are shown in Table 1:

TABLE 1
Rule: Reason

RULE00: This rule is for sampled packets
(used for traffic statistics gathering).
RULE00 has a configured CPU queue of 1.
RULE01: This rule is for packets with
new MAC source addresses (learns).
RULE01 has a configured CPU queue of 3.
RULE02: This rule is for IP (Internet
Protocol) route updates.
RULE02 has configured CPU queue of 5.
RULE03: This rule is for packets
indicating security violations.
RULE03 has a configured CPU queue of 4.
Note that the copy rules 128 may be reprogrammed by the copy rule management engine software 136 running on the CPU 130, so that a copy rule may be re-assigned to other CPU queues that are different from the configuration listed above in Table 1.

As an example, a received packet 115 would fire (i.e., trigger) RULE00 if the packet 115 is a sample packet, and would be sent by the forwarding engine 125 to CPU 130 on CPU queue 1 with a reason (bitmap) 160 (FIG. 1) of 0001₂ (i.e., bit 0 of the copy rule 128 is set, indicating that RULE00 was activated). The CPU 130 will then perform the appropriate processing of the packet 115.

As another example, a received packet 115 would fire RULE01 if the packet 115 indicates a new MAC (Media Access Control) source address in the packet header 150, and would be sent by the forwarding engine 125 for buffering on CPU queue 3 and processing by the CPU 130.

As another example, a received packet 115 would fire RULE02 if the packet 115 is an IP route update, and would be sent by the forwarding engine 125 for buffering on CPU queue 5 and processing by the CPU 130. For example, the CPU 130 will parse the packet 115 so that the CPU 130 can program the hardware forwarding tables 127 to reflect the IP route update.

As another example, a packet 115 that is both a learn (has new MAC source address) and indicates security violation, would be sent by the forwarding engine 125 to the CPU 130 on CPU queue 4 with a reason of 1010₂ (i.e., bits 1 and 3 of the reason are set, indicating that RULE01 and RULE03 were triggered). Note in this case that the packet 115 is placed in the CPU queue 4 which is the programmed queue of the highest priority matching rule, RULE03 in this example. The CPU 130 can then process the packet 115 so that a response can be generated to both the security violation and the new MAC source address.

Note also that the above copy rules 128 may be changed for detecting other packet types (i.e., the reason for a rule 128 may be changed) or may be limited to a core set of rules that will fire for packets that are used for basic network learning functions, as noted in the above-mentioned U.S. patent application Ser. No. 11/198,056.

Penalty Queue State & Violation Disable State

An embodiment of the invention allows ports on a switch or router to be placed into a restricted state. In such a state, packets which are identified as being a security violation and which may be copied to the CPU, will have a restriction placed on the packets. This restriction can be used to either force the packets into a specific programmable CPU queue (a penalty queue) when the port is placed in the penalty queue state, or force the packets to not be copied at all to the CPU when the port is placed in the violation disable state.

These restricted states allow violation packets, security violations, denial of service type attack, virus propagations, or/and other abnormal traffic conditions to be localized on one or more ports on the network device, so that the CPU 130 can be protected from being overwhelmed by packet traffic occurring during these abnormal traffic conditions. Only the port which is receiving the abnormal traffic pattern is placed in a restricted state, and the unaffected ports will continue to be in the normal state.

For example, assume that port 110H in FIG. 1 is a specific port that connects only to an end-node 162, although this example is applicable to any one of the ports 110 as well. The end-node 162 is, for example, a computer, server, or another type of device in a network. Assume further in this example that the port 110H can be configured such that only a single MAC source address and IP source address are ever expected to be seen on this port 110H. In this setup, the end-node 162 is bound to the port 110H and only the addresses of the end-node 162 are valid on the port 110H. During normal operation (i.e., normal state 140), all packets from the end-node 162 will meet the security criteria and be forwarded normally with no CPU intervention or will be copied to the CPU when the packet information matches a copy rule 128, as previously discussed above. However, if the end-node 162 is replaced by a different end-node, or the end-node 162 is used for malicious or abnormal activity, then some or all of the packets 164 that are received on the port 110H of the network device 105 will generate security violations. In this case, the packet information 165 of the packet 164 will indicate a source address 167 (MAC source address or/and IP source address) that are different from the MAC source address and IP source address that are expected on the port 110H. The packet information 165 can also include other information such as, for example, the packet type 168, packet destination addresses 169, and other information associated with the packet 164. The forwarding engine 125 compares the packet information 165 (including the MAC source address and IP source address) of the violation packet 164 with the MAC source address and IP source address that are expected on the port 110H. The MAC source address and IP source address that are expected on the port 110H are stored in the forwarding tables 127 of the forwarding engine 125.

The packets 164 may be, for example, packets generated due to security violations, denial of service type attack, virus propagations, packets with many new addresses, a sudden spike in traffic load, a sudden flood of specific protocol packets, or other unusual or abnormal traffic activities.

At some point, these violation packets 164 may overwhelm the CPU 130 and may begin to impact normal switch or router functionalities. The port state engine 132 may count the number of violation packets 164 in, for example, a counter 166. The port state engine 132 will change the state of the port 110H from the normal state 140 to the penalty queue state 141 when violation packets 164 are being received at the port 110H. As an example, the port state engine 132 stores a programmable first threshold rate in which the violation packets 164 can be received by the port 110H. The first threshold rate can be set at, for example, 100 packets per second, although other rate values can be set for the first threshold rate. When the rate of violation packets 164 received at port 110H exceeds the first threshold rate, then the port state engine 132 will set the port 110H from the normal state 140 to the penalty queue state 141. Other techniques may be used to determine when the state of a port will change from the normal state 140 to the penalty queue state 141.

When the port 110H is placed in the penalty queue state 141, the packets 164 that are causing violations will typically be copied to the CPU 130 for investigation and may trigger an alert to the system administrator. These packets will now, however, be copied to a lower priority CPU queue as the port 110H is in the penalty queue state 141. As mentioned above, the port state engine 132 can set the state of any of the other ports 110A-110G into the penalty queue state 141. For example, if port 110G is receiving violation packets 164 that exceed the first threshold rate, then the port state engine 132 will set the port 110G from the normal state 140 to the penalty queue state 141. The ports 110 that are in the normal state 140 will continue to perform the normal functions as discussed above.

In an embodiment of the invention, when the port 11OH is placed in the penalty queue state 141, the device hardware 120 will copy the violation packets 164 to a penalty queue. For example, the port state engine code 132 can set the penalty queue to be CPU queue 0 in FIG. 1. The penalty queue does not have to be a specific queue that is reserved exclusively for penalized packets. It is just another queue that can also be used by other low priority packets if desired. The port state engine code 132 can set the penalty queue to be the CPU queue with the lowest priority. In other words, CPU queue 0 will be a lower priority CPU queue than the CPU queues 1-7. As a result, the CPU 130 will process the copied packets in CPU queues 1 through 7 at higher priority than the CPU's processing of the copied violation packets 164 in the penalty queue 0. Since the violation packets 164 are placed in a low priority CPU queue, the CPU 130 is protected from being overwhelmed by having to process the violation packets 164 at their normal priority. In contrast, when the port 110H is in the normal state 140, a violation packet 164 received by the port 110H is placed in CPU queue 4 as noted in Table 1 above.

Ultimately, the port 110H can be set to the violation disable state 142, in which case violation packets 164 from the port 110H will no longer be copied to the CPU 130 at all. In an alternative embodiment of the invention, if the violation packet 164 also fits in some other criteria for copying to the CPU (i.e., triggers one of the copy rules 128 other than a rule that is triggered due to a security violation), then the violation packet 164 will still be copied to the CPU 130 for that reason associated with the copy rule that is triggered.

The port state engine 132 will change the state of the port 110H from the penalty queue state 141 to the violation disable state 142 when violation packets 164 are being received at the port 110H. As an example, the port state engine 132 also stores a programmable second threshold rate in which the violation packets 164 can be received by the port 110H. The second threshold rate can be set at, for example, 300 packets per second, although other rate values can be set for the second threshold rate. When the rate of violation packets 164 received at port 110H exceeds the second threshold rate, then the port state engine 132 will set the port 110H from the penalty queue state 141 to the violation disable state 142. Other techniques may be used to determine when the state of a port will change from the penalty queue state 141 to the violation disable state 142. As an example, the second threshold rate may be exceeded by packets in the port 110H if the end-node 162 is infected with a virus that generates packets with different source addresses or is performing a DoS type attack. When the port 110H is placed in the violation disable state 142, the packets 164 that are causing violations will no longer be copied to the CPU 130 (i.e., the packets 164 will not be placed in any of the CPU queues and will not be processed by the CPU 130). Therefore, the CPU 130 will never even receive the violation packets 164. The ports 110 that are in the normal state 140 will continue to perform the normal functions as discussed above.

Note that normal packets (i.e., packets not causing a violation) will not be affected by the restrictions under the penalty queue state 141 and violation disable state 142. Only those packets that generate a violation will typically be affected by the restrictions under the penalty queue state 141 and violation disable state 142.

Note also that an embodiment of the invention allows the port state engine 132 to set the port 110H (or other ports) from the violation disable state 142 to the penalty queue state 141 when the second threshold rate is no longer exceeded by the violation packets 164 received by the port 110H, and to set the port 110H (or other ports) from the penalty queue state 141 to the normal state 140 when the first threshold rate is no longer exceeded by the violation packets 164 received by the port 110H. Also note that in practice, typically, these rates would be time averaged, not instantaneous, and also contain hysteresis to aid system stability. Additionally or alternatively, the port state engine 132 can set the port 110H (or other ports) from the penalty queue state 141 or the violation disable state 142 to the normal state 140 after system boot-up, after system reset, after a specific time has expired, e.g. 10 seconds, or after user intervention, for example.

This invention allows a finer control over the CPU queue that a copied packet is sent to based upon port configuration. This allows ports that are identified as receiving unusual traffic patterns (e.g., many new addresses, a sudden spike in traffic load, a sudden flood of specific protocol packets, or other unusual traffic activities) to be placed into a penalty queue state and/or a violation disable state. These restrictive states can be configured to limit the amount of packet traffic that can be copied to the CPU from the port in question and also to restrict the CPU queue that such traffic can be placed into. Thus traffic is re-prioritized based upon the port-configuration.

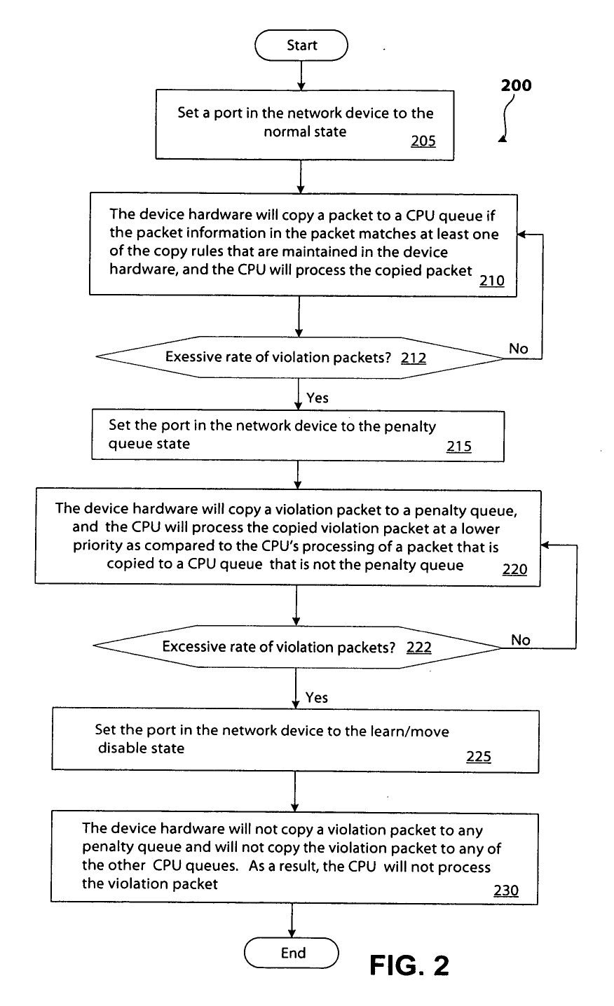

FIG. 2 is a flowchart of a method 200, in accordance with an embodiment of the invention. In block 205, a port in a network device 105 is set to the normal state. As a result, in block 210, the device hardware 120 in the network device 105 will copy a packet (received by the port) to a CPU queue, if the packet information in the packet matches at least one of the copy rules 128 that are maintained in the device hardware 120, and the CPU will process the copied packet.

In block 212, if the port receives an excessive rate of violation packets that are to be copied to the CPU, then the port is set to the penalty queue state and the method 200 proceeds to block 215. For example, an excessive rate of violation packets will exceed a programmable first threshold rate in which the violation packets can be received by the port. On the other hand, if the port is not receiving an excessive rate of violation packets, then the port remains in the normal state.

In block 215, the port is set to the penalty queue state. As a result, in block 220, the device hardware 120 will copy a violation packet to a penalty queue, and the CPU will process the copied packets in the non-penalty queues at a higher priority than the copied violation packet in the penalty queue.

In block 222, if the port receives an excessive rate of violation packets that are to be copied to the CPU, then the port is set to the violation disable state and the method 200 proceeds to block 225. For example, an excessive rate of violation packets will exceed a programmable second threshold rate in which the violation packets can be received by the port. On the other hand, if the port is not receiving an excessive rate of violation packets, then the port remains in the penalty queue state.

In block 225, the port is set to the violation disable state. As a result, in block 230, the device hardware 120 will not copy a violation packet to the penalty queue and will not copy the violation packet to any of the other CPU queues. As a result, the CPU will not process the violation packet.

Multiple CPUs, with Independent Queues for Each CPU (Copy Location)

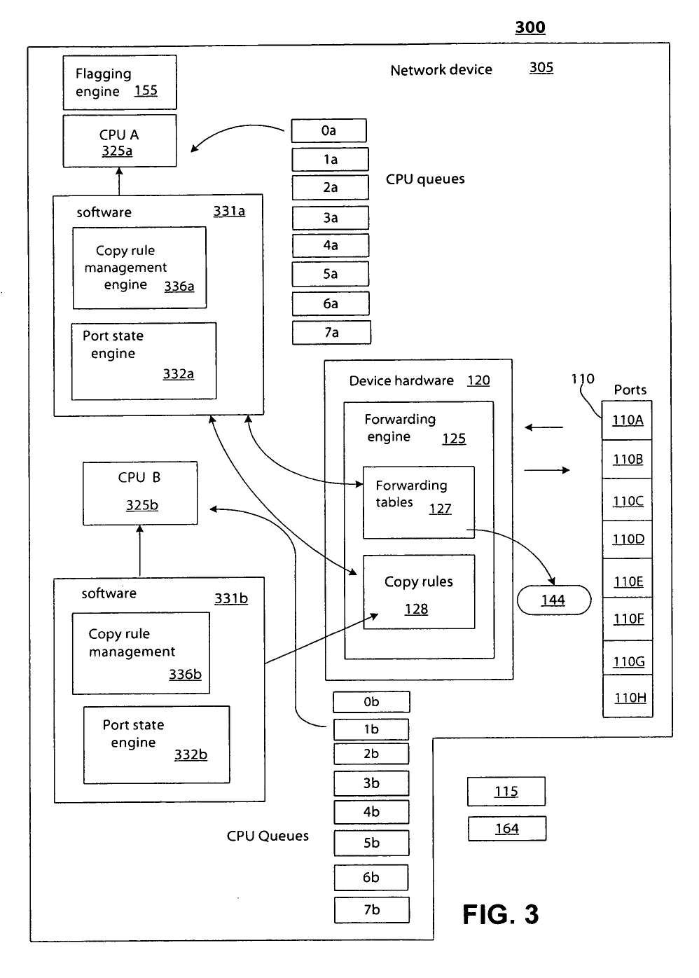

FIG. 3 is a block diagram of a system (apparatus) 300, in accordance with another embodiment of the invention, where a network device 305 includes multiple CPUs 325a and 325b. This embodiment permits a very efficient technique and increased robustness for the processing of packet traffic in a distributed CPU system. Note that the number of CPUs (N) may vary, where N is a suitable integer value. Each CPU controls its own set of queues. For example, CPU (A) 325a controls the queues 0a through 7a, and CPU (B) 325b controls the queues 0b through 7b. The number of queues controlled by each CPU may vary in number.

The copy rule management engine 336a in software 331a executing on CPU 325a assigns a particular set of the copy rules 128 (e.g., RULES 00 and 01 or other copy rules) to the CPU queues Oa-7a. The copy rule management engine 336b in software 331b executing on CPU 325b assigns another particular set of copy rules 128 (e.g., RULES 02 and 03 or other copy rules) to the CPU queues 0b-7b. If the packet 115 matches a copy rule that is assigned to one of the CPU queues 0a-7a, then the packet 115 is buffered in one of the CPU queues 0a-7a and then processed by the CPU 325a. On the other hand, if the packet 115 matches a copy rule that is assigned to one of the CPU queues 0b-7b, then the packet 115 is buffered in one of the CPU queues 0b-7b and then processed by the CPU 325b. It is also possible for a copy rule to be assigned to more than one CPU, for example a copy rule can be assigned to one of the queues 0a-7a for CPU 325a and also to one of the queues 0b-7b for CPU 325b. In this case, both CPU 325a and CPU 325b will receive a copy of the packet for processing. Note that in this case, the queues assigned to each CPU do not have to be identical, for example, a single packet 115 can be copied to CPU queue 3a of CPU 325a and also to CPU queue 7b of CPU 325b.

Also, typically one CPU (e.g., CPU 325a) would manage the device hardware 120, while another CPU (e.g., CPU 325b) could send messages to CPU 325a in order to instruct the CPU 325a to reprogram the CPU queues (i.e., re-prioritize the copy queues) or to reprogram the copy rule priorities (i.e., re-prioritize the copy rules), or to change other configurations.

Software 331a executing on the CPU 325a has a port state engine 332a that can assign any of the ports 110 to the normal state 140, penalty queue state 141, or violation disable state 142, so that the functions described above for these states can be performed. In the normal state, the device hardware 120 will copy a packet to one of the CPU queues 0a-7a, if the packet information in the packet matches at least one of the copy rules 128 that are maintained in the device hardware 120, and the CPU 325a will process the copied packet. In the penalty queue state, the device hardware 120 will copy a violation packet 164 to a penalty queue (e.g., CPU queue 0a), and the CPU 325a will process the copied violation packet 164 at a lower priority as compared to the CPU's processing of a packet that is copied into a CPU queue that is not the penalty queue. In the violation disable state, the device hardware 120 will not copy a violation packet 164 to any of the queues 0a-7a and 0b-7b, and as a result, the CPUs 325a and 325b will not process the violation packet 164.

Software 331b executing on the CPU 325b has port state engine 332b that can also assign any of the ports 110 to the normal state 140, penalty queue state 141, or violation disable state 142, so that the functions described above for these states can be performed. The CPU queue 0b can be programmed as the penalty queue that stores copied violation packets 164 when a port is in the penalty queue state.

As another example, in the penalty queue state, the device hardware 120 will copy a violation packet 164 to both the penalty queue 0a in the CPU queue group 0a-7a and the penalty queue 0b in the CPU queue group 0b-7b. As a result, both CPUs 325a and 325b can process the violation packets 164.

In another embodiment of the invention, the port state engine 332a can assign a certain number of the ports 110 (e.g., ports 110A-110D) to the normal state 140, penalty queue state 141, or violation disable state 142. On the other hand, the port state engine 332b can assign the rest of the ports 110 (e.g., ports 110E-110H) to the normal state 140, penalty queue state 141, or violation disable state 142.

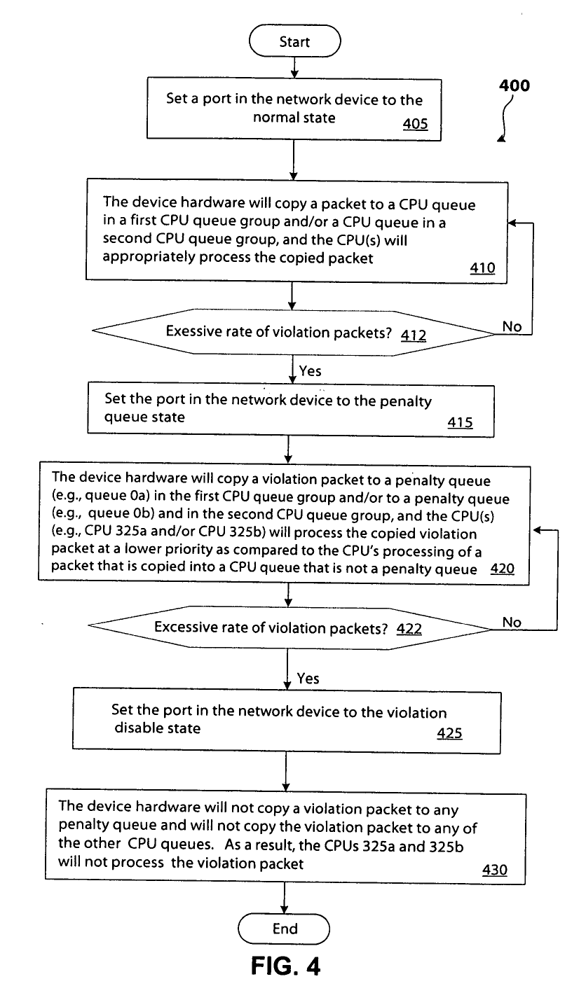

FIG. 4 is a flowchart of a method 400, in accordance with an embodiment of the invention with multiple CPUs and multiple groups of CPU queues. In block 405, a port in a network device 305 is set to the normal state. As a result, in block 410, the device hardware 120 in the network device 305 will copy a packet (received by the port) to a CPU queue in a first CPU queue group (e.g., CPU queues 0a-7a in the FIG. 3 example) and/or a CPU queue in a second CPU queue group (e.g., CPU queues 0b-7b), if the packet information in the packet matches at least one of the copy rules 128 that are maintained in the device hardware 120, and the CPU(s) (e.g., CPU 325a and/or CPU 325b) will appropriately process the copied packet.

In block 412, if the port receives an excessive rate of violation packets that are copied to the CPU, then the port is set to the penalty queue state and the method 400 proceeds to block 415. For example, an excessive rate of violation packets will exceed a programmable first threshold rate in which the violation packets can be received by the port. On the other hand, if the port is not receiving an excessive rate of violation packets, then the port remains in the normal state.

In block 415, the port is set to the penalty queue state. As a result, in block 420, the device hardware 120 will copy a violation packet to a penalty queue (e.g., CPU queue 0a) in the first CPU queue group and/or to a penalty queue (e.g., CPU queue 0b) in the second CPU queue group, and the CPU(s) (e.g., CPU 325a and/or CPU 325b ) will process the copied violation packet at a lower priority as compared to the CPU's processing of a packet that is copied into a CPU queue that is not a penalty queue.

In block 422, if the port receives-an excessive rate of violation packets that are copied to the CPU, then the port is set to the violation disable state and the method 400 proceeds to block 425. For example, an excessive rate of violation packets will exceed a programmable second threshold rate in which the violation packets can be received by the port. On the other hand, if the port is not receiving an excessive rate of violation packets, then the port remains in the penalty queue state.

In block 425, the port is set to the violation disable state. As a result, in block 430, the device hardware 120 will not copy a violation packet to any of the penalty queues 0a and 0b and will not copy the violation packet to any of the non-penalty queues (i.e., CPU queues 1a-7a and 1b-7b). As a result, the CPUs 325a and 325b will not process the violation packet.

Using the Restricted States as Search Key in an ACL-Style Search

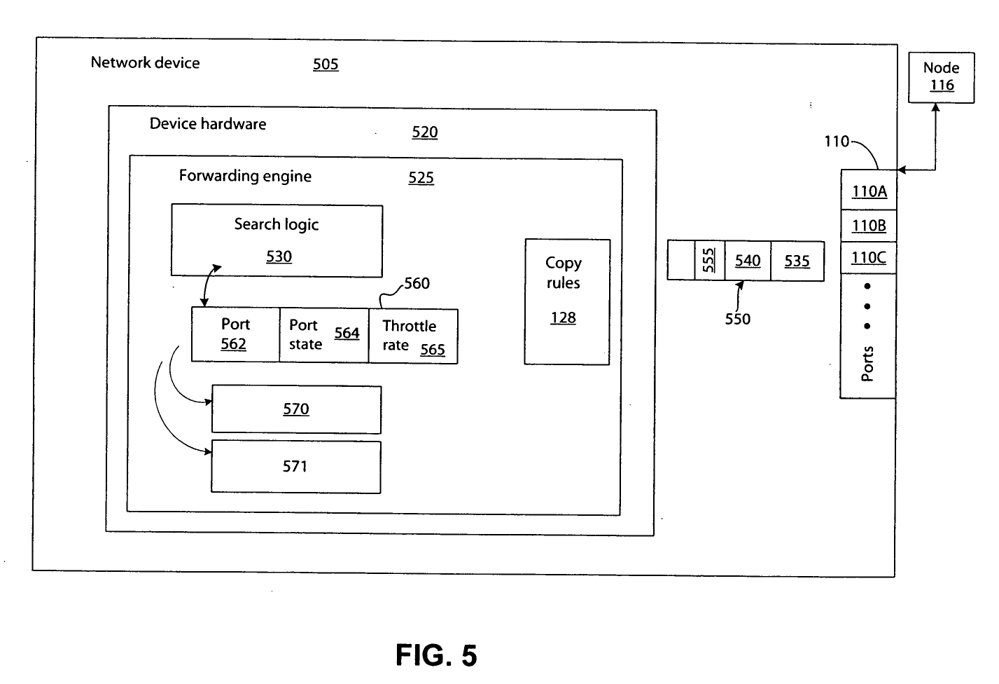

FIG. 5 is a block diagram of a subsystem, in accordance with another embodiment of the invention. As an optional feature, a forwarding engine 525 which is included in the device hardware 520 in a network device 505, has the ability to use the port security configuration (i.e., normal state 140, penalty queue state 141, and violation disable state 142) as a part of a search key into normal Access Control List (ACL) style lookups or into other suitable lookup methods related to packet forwarding decisions or packet filtering decisions. The forwarding engine 525 includes search logic 530 (e.g., ACL search logic) that allows searching of certain fields in a packet 535. For example, the search logic 530 can search using the packet information 540 for source or destination MAC address, source or destination IP address, physical (source) port number receiving the packet, packet protocol, TCP source or destination port numbers, TCP code bits, and/or other information in the packet 535. The search logic 530 uses a general purpose search logic to search the fields in the packet 535, for example, Content Addressable Memory (CAM) or hashing. The search logic 530 is also passed the actual state (normal state 140, penalty queue state 141, or violation disable state 142) of the particular port 110 that received the packet 535 by means of a port state field 555 in the packet header 550.

By allowing the search logic 530 to perform search operations based in the packet information 540 in conjunction with the port state field 555, additional ACL entries can be programmed into the search logic 530 by the CPU 130. For example, when a port 110 is in the penalty queue state 141, the CPU queue that packets from such a port are copied to is restricted to a penalty queue, as has already been described. In addition to this penalty queue, it is also possible to apply a rate limiting mechanism (herein referred to as a throttling mechanism) to such copied packets, thus restricting the rate at which such copied packets are actually sent to the CPU 130. Note that packets must actually be marked as a copy by matching with one, or more, of the copy rules 128 as previous described, for the packets to be considered a part of the throttling mechanism applied to copied packets. Stated alternatively, only packets that are actually copied to the CPU will be throttled.

To implement this throttling, an ACL entry 560 is programmed into the search logic 530 by the CPU 130. In its simplest form, this entry 560 specifies the specific port in entry field 562, e.g., port 110H, the port state in entry field 564 (i.e., normal state 140, penalty queue state 141 and violation disable state 142), and the throttle rate in entry field 565 (i.e., allowed copy rate). For example, a port 110H may be limited to only copying 50 packets per second to the CPU 130 when the port 110H is in the penalty queue state 141, and limited to only copying 10 packets per second to the CPU 130 when the port 110H is in the violate disable state 142. A more complex matching criteria may be programmed by the CPU 130 using other fields already available to the search logic 530 to further shape traffic copied to the CPU 130. For example, throttling the number of copied ICMP echo request or echo reply (i.e., ping) packets, or throttling the number of copied ARP request or reply packets may be programmed as other matching criteria.

In addition to modifying which packets are copied to a CPU 130 for further inspection, it is also possible to further restrict how packets are forwarded to their destination. For example, consider an original ACL entry that has been programmed to permit (i.e., allow) all new TCP connections to TCP port 80 from a host on one of the ports 110 (e.g. node 116 on port 110A). By taking into account the port state field 555, two new ACL entries 570 and 571 could be created based on the original ACL entry 560. The first of these new ACL entries would match only if port 110A was in the penalty queue state 141 and could specify an action that is different to the permit action of the original ACL entry—for example it may specify a throttle action to restrict the rate of such packets to 10 per second, thus limiting the allowed rate of new connections to TCP port 80 from the node 116 connected to port 110A. The second additional ACL entry would match only if port 110A was in the violation disable state 142, and could specify yet another different action, for example a deny (drop) action that would not permit any new connections to TCP port 80 from the node 116 connected to port 110A. Note that it is also possible to combine port state values in a single ACL entry, for example an ACL entry that matches if the port 110A is in either the penalty queue state 141 or the violation disable state 142.

Using the Restricted States to Make a New Forwarding Decision

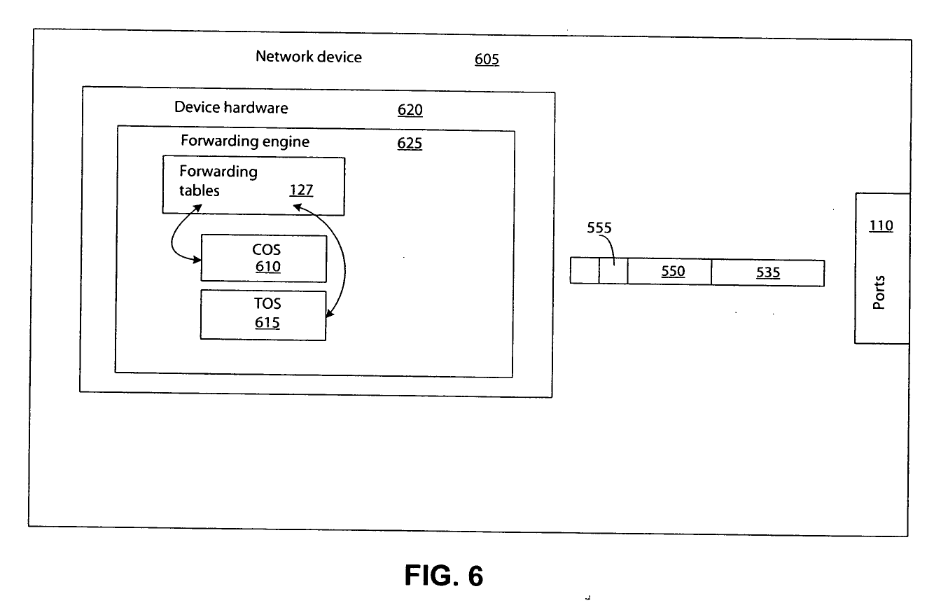

Referring to FIG. 6, another embodiment of the invention allows the port state field 555 values to be stored as a part of the forwarding tables 127 in a network device 605. As has already been described, the forwarding tables 127 are used to determine which of the ports 110 that the packet should be sent to, and how the packet should be modified (e.g., changes to MAC source and destination addresses, etc.) to allow it to be sent on towards its final destination. Such a forwarding decision is typically made based on the destination MAC address and destination IP address (for routed IP packets), although other packet fields may be used in addition to, or in some cases in place of, these fields, for example source addresses, packet VLAN or MPLS tags, Type of Service (ToS) information, etc.

By additionally storing a port state value in the forwarding tables 127, it is now possible for the forwarding engine 625 (in the device hardware 620) to make different forwarding decisions based on the actual port state (normal state 140, penalty queue state 141 or violation disable state 142) of the particular port 110 that received the packet 535. Again, this actual port state is carried by means of the port state field 555 in the packet header 550. For example, in many networks it is common to have more than one path to a specific destination network, but typically only the single best path is used to route packets to this specific network. The “best path” is generally determined by routing protocols, but can be modified to some degree by the user to reflect the path with, for example, the highest available bandwidth, lowest latency, highest reliability, lowest monetary cost, etc.

In this embodiment, packets received from a port 110 that is in the normal state 140 would follow the “best path” as described above. In the example of FIG. 6, assume that the forwarding engine 625 selects one of the ports 110 (e.g. port 110B) as the best path for routing a particular packet. However, packets received from a port 110 that is in the penalty queue state 141 or the violation disable state 142 could be forwarded by the forwarding engine 625 out of port 110C, which would result in them taking a different path through the network that is, for example, less reliable or has a lower bandwidth. Such packets are thus penalized by traversing a sub-optimal path (or less optimal path) towards the destination, and in addition to this the optimal (“best”) path is not burdened with these penalized packets. Note that in addition to potentially sending the packet out of a different port 110, it may also be necessary to use a different destination MAC address when modifying the packet.

A second method of penalizing such packets (received by a port 110 in the restricted states 141 or 142) is to downgrade the Class of Service (CoS) and/or Type of Service (ToS) that each packet is allowed to receive by other switches/routers in the path to the final destination. The CoS value 610 represents the priority of the packet from 0 to 7, with 7 being the highest priority. This value 610 can be carried at layer 2 in the VLAN tag of a packet. The ToS value 615, which is a part of the IP header of IP packets, can contain either a priority from 0 to 7, or a codepoint value. The codepoint value maps to a priority and an indication of how “droppable” a packet is. This can be used by switches/routers to intelligently drop (discard) packets when a link is congested, with more “droppable”packets being more likely to be dropped (discarded).

A packet received from a port 110 that is in the normal state 140 would be given standard values of CoS and ToS as defined by user policies for the specific packet type in question. However, if a packet is received from a port 110 that is in the penalty queue state 141 or the violation disable state 142, then the CoS and/or ToS values assigned to the packet would be downgraded from the standard values. Such a downgraded value could be, for example, a lower priority value for CoS, or in the case of ToS a downgraded codepoint that maps to a lower priority value and/or a higher “dropability” value (i.e. the packet is now more likely to be dropped by switches/routers along the path to the destination when congestion is encountered).

It should be noted that other non-ethernet transport technologies (e.g. ATM, frame relay, MPLS tunnels, etc.) may use different fields to indicate packet priority or importance, but the principle involved is essentially the same. Thus the method of downgrading packets based on the state of the input port 110 is equally applicable to such alternative transport technologies, and therefore, embodiments of the invention are not limited to any specific transport technologies or protocols.

Various elements in the drawings may be implemented in hardware, software, firmware, or a combination thereof.

The various engines or software discussed herein may be, for example, computer software, firmware, commands, data files, programs, code, instructions, or the like, and may also include suitable mechanisms.

Reference throughout this specification to “one embodiment”, “an embodiment”, or “a specific embodiment”means that a particular feature, structure, or characteristic described in connection with the embodiment is included in at least one embodiment of the invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for a per-port penalty queue system in a network device, the method comprising:
selecting a state for a port in the network device;
wherein the selected state comprises either a normal state or a restricted state;
wherein the normal state permits a packet received at the port to be copied to a first queue; and
wherein the restricted state causes the packet to be copied to a penalty queue which has lower priority than the first queue or causes the packet to not be copied to a queue.

2. The method of claim 1, wherein the restricted state comprises a penalty queue state which causes the packet to be copied to the penalty queue.

3. The method of claim 1, wherein the penalty queue may be set with a lowest priority.

4. The method of claim 1, wherein a packet placed in the penalty queue is processed at a lower priority by a processor than another packet placed in the first queue.

5. The method of claim 1, wherein the restricted state comprises a violation disable state which causes the packet to not be copied to a queue.

6. The method of claim 1, wherein the restricted state is set based upon an abnormal traffic condition at the port.

7. The method of claim 1, wherein the network device comprises a network switch.

8. The method of claim 1, wherein the network device comprises a router.

9. The method of claim 1, further comprising:
using the state on the receiving port to determine a forwarding decision on the packet.

10. The method of claim 1, further comprising:
using the state of the port receiving the packet as part of a search key into a lookup related to packet forwarding decisions or packet filtering decisions.

11. The method of claim 1, further comprising:
throttling packets that are copied to the penalty queue so that a rate is restricted for the copied packets that are sent to the CPU.

12. The method of claim 1, further comprising:
using the state of the port receiving the packets so that a restriction is placed on the forwarding of the packets to the packet destinations.

13. The method of claim 1, further comprising:
using the state of the port receiving the packets, in order to make a new forwarding decision on the packets.

14. The method of claim 1, further comprising:
selecting a different path for routing a packet received by a port in the restricted state.

15. The method of claim 1, further comprising:
downgrading a Class of Service (CoS) for a packet received by a port in the restricted state, where CoS represents a priority of the packet.

16. The method of claim 1, further comprising:
downgrading a Type of Service (ToS) for a packet received by a port in the restricted state, where ToS contains a codepoint value indicating at least one of (1) a priority of the packet and (2) a likelihood that the packet will be discarded when there is link congestion.

17. An apparatus for a per-port penalty queue system, the apparatus comprising:
a network device configured selecting a state for a port in the network device;
wherein the selected state comprises either a normal state or a restricted state;
wherein the normal state permits a packet received at the port of the network device to be copied to a first queue; and
wherein the restricted state causes the packet to be copied to a penalty queue which has lower priority than the first queue or causes the packet to not be copied to a queue.

18. The apparatus of claim 17, wherein the restricted state comprises a penalty queue state which causes the packet to be copied to the penalty queue.

19. The apparatus of claim 17, wherein the penalty queue may be set with a lowest priority.

20. The apparatus of claim 17, wherein a packet placed in the penalty queue is processed at a lower priority by a processor than another packet placed in the first queue.

21. The apparatus of claim 17, wherein the restricted state comprises a violation disable state which causes the packet to not be copied to a queue.

22. The apparatus of claim 17, wherein the restricted state is set based upon an abnormal traffic condition at the port.

23. The apparatus of claim 17, wherein the network device comprises a network switch.

24. The apparatus of claim 17, wherein the network device comprises a router.

25. The apparatus of claim 17, wherein the network device is configured to use the state on the receiving port to determine a forwarding decision on the packet.

26. The apparatus of claim 17, wherein the network device comprises: a forwarding engine configured to use the state of the port receiving the packet as part of a search key into a lookup related to packet forwarding decisions or packet filtering decisions.

27. The apparatus of claim 17, wherein the network device comprises: a forwarding engine configured to throttle packets that are copied to the penalty queue so that a rate is restricted for the copied packets that are sent to the CPU.

28. The apparatus of claim 17, wherein the network device comprises: a forwarding engine configured to use the state of the port receiving the packets so that a restriction is placed on the forwarding of the packets to the packet destinations.

29. An apparatus for a per-port penalty queue system in a network device, the apparatus comprising:
means for selecting a state for a port in the network device; wherein the selected state comprises either a normal state or a restricted state; wherein the normal state permits a packet received at the port to be copied to a first queue; and wherein the restricted state causes the packet to be copied to a penalty queue which has lower priority than the first queue or causes the packet to not be copied to a queue.

30. An article of manufacture, comprising:
a machine-readable medium having stored thereon instructions to:
select a state for a port in the network device;
wherein the selected state comprises either a normal state or a restricted state;
wherein the normal state permits a packet received at the port to be copied to a first queue; and
wherein the restricted state causes the packet to be copied to a penalty queue which has lower priority than the first queue or causes the packet to not be copied to a queue.
